(19) United States
(12) Patent Application Publication
(10) Pub. No.: US 2024/0062080 A1
(43) Pub. Date: Feb. 22, 2024

(54) SYSTEM FOR AND METHOD OF MULTIPLE MACHINE LEARNING MODEL AGGREGATION

(71) Applicant: Crowley Government Services, Inc., Jacksonville, FL (US)

(72) Inventors: Bhaskar Mandapaka, Toronto (CA); Neil Athavale, Jacksonville, FL (US); Anoop Mohandas, Saint Johns, FL (US); Shashank Panchangam, Fulshear, TX (US); Ashwani Dev, Jacksonville, FL (US); Carey Hepler, Jacksonville, FL (US); Shiju Zacharia, Jacksonville, FL (US); Chris Wolfi, Saint Johns, FL (US); Smijith Kunhiraman, Jacksonville, FL (US)

(21) Appl. No.: 18/449,534

(22) Filed: Aug. 14, 2023

Related U.S. Application Data
(60) Provisional application No. 63/399,554, filed on Aug. 19, 2022.

(51) Int. Cl. G06N 5/022

(52) U.S. Cl. CPC G06N 5/022

(57) ABSTRACT

Systems, methods, and computer-readable storage media for aggregating the outputs of multiple machine learning models, then using the output of yet another machine learning model as a multiplier to obtain a final prediction. A system can receiving a plurality of data sets, each data set being associated with at least one data type, and train machine learning models, each model associated with one or more of the different data types. Upon execution, the multiple machine learning models can each produce a prediction which is aggregated together to form an aggregated prediction. The multiplier from the additional machine learning model can then be applied to the aggregated prediction, resulting in a final prediction.

### CROSS-REFERENCE TO RELATED APPLICATION

This application claims priority benefit from U.S. Provisional Patent Application No. 63/399,554, filed on Aug. 19, 2022, the entire content of which is incorporated herein by reference.

### BACKGROUND

### 1. Technical Field

The present disclosure relates to aggregating multiple machine learning models, and more specifically to combining results from multiple machine learning models to obtain a final result.

### 2. Introduction

Machine learning models are algorithms used to recognize certain types of patterns. Once a model is trained, the model can be executed using new data, resulting in a prediction about the new data.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a plurality of data sets, wherein each data set within the plurality of data sets is associated with at least one data type within a plurality of data types; training, via at least one processor of the computer system using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving, at the computer system, real-time data type values associated with the plurality of data types; executing, via the at least one processor, the plurality of machine learning models using the real-time data type values as inputs, resulting in a plurality of predictions; and generating, via the at least one processor aggregating the plurality of predictions, a final prediction.

A system configured to perform the concepts disclosed herein can include: at least one processor; and a non-transitory computer-readable storage medium having instructions which, when executed by the at least one processor, cause the at least one processor to perform operations comprising: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

A non-transitory computer-readable storage medium configured as disclosed herein can have instructions stored which, when executed by a computing device, cause the computing device to perform operations which include: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

### BRIEF DESCRIPTION OF THE DRAWINGS

FIG. 1 illustrates a first example system configuration;

FIG. 2 illustrates an example of timing the training of the machine learning models;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Machine learning models often rely on the aggregation of multiple different types of data. For example, training a machine learning model often includes constructing a neural network, where multiple different types of data can be analyzed (e.g., using a multi-layer regression analysis), with the result being a single machine learning model. To use that single machine learning model, the user will input new or current data type values corresponding to (i.e., associated with) the data used to train the model, with the output being a prediction based on the combined variables.

However, training the single machine learning model requires a great deal of processing time, with additional training being required each time the data associated with any given variable is sufficiently updated. For example, if the machine learning model were trained using variables “A” “B” and “C”, if the data associated with variable “A” were updated it would cause the entirety of the machine learning model to be updated, despite variables “B” and “C” not changing.

By contrast, systems configured as disclosed herein can train multiple distinct machine learning models, resulting in multiple machine learning models. The training data for the machine learning models can be a combination of industry-specific and broader, non-industry specific data. In one possible scenario, the training data is split into multiple sets, where each dataset will have its own model (or models), and all features for the models constructed using a given dataset are identical. In another possible scenario, the data is again split into multiple sets where each dataset will have its own model (or models), however in this scenario the features for the models constructed from a given dataset will not be identical due to differences in how the datasets are analyzed by the machine learning model training algorithm(s). To execute a model, the system uses real-time data type values which correspond to the dataset used to train the model. For example, if a dataset containing historical values of XYZ were used to train a model, real-time data type values of XYZ would be used as inputs to the execution of that model. If executing multiple models, real-time data type values corresponding to (i.e., associated with) the datasets used to train the different models will be used as inputs. When executed, the system can combine/aggregate the results of the multiple machine learning models together. If there are industry-specific indicators associated with the multiple machine learning models, a separate machine learning model can be trained which applies a multiplier to the aggregated output, resulting in a final prediction. For example, the predictions (i.e., outputs) from multiple models can be aggregated together, with the aggregated value(s) accounting for long term data trends, then a multiplier can be applied to that aggregated value(s)—thereby adjusting the aggregated value(s) to the most recent data trends.

The aggregation of outputs from the multiple machine learning models can occur through any accepted mechanism known to those skilled in the art. For example, in some configurations, the aggregation can be an average of the outputs from the multiple machine learning models. In other configurations, a weight can be assigned to each model within the multiple machine learning models. The weight can, for example, be based on how accurate each model has been during previous iterations. During aggregation, the output of each model can be multiplied by the weight associated with that model, then the weighted results can be added together to form the aggregated result. In some configurations, the system can use a random forest algorithm (e.g., a regression or decision tree) to identify which of the multiple machine learning model outputs should be used. Other non-limiting examples of possible algorithms which can be used can include a Feed Forward Neural Network, LSTM (Long Term Short Memory), and/or SVR (Support Vector Regression).

The machine learning multiplier model can use (for both training and subsequent model inputs) industry specific indicators associated with the data being input into the multiple machine learning models, the overall field being analyzed, and/or the specific data being predicted. If, for example, the system is being used to make predictions on freight price estimation for a given load, the industry specific indicators may include PPI (Producer Price Index, the average change over time in the selling prices received by domestic producers for their output), a truck to load ratio, number of licensed drivers, etc. If the system is being used to make predictions of the time required to going through airport security at a given location on a given day, the industry specific indicators may include information regarding the number of x-ray machines and luggage scanners in operation, the number of TSA (Transportation Security Administration) personnel scheduled for that day, the experience levels of those TSA personnel, etc.

In configurations associated with specific locations (such as freight, transportation, acquisition of raw resources (e.g., farming, forestry, mining), manufacturing), the system may normalize location data before inputting that normalized location data into an associated machine learning model. In addition, the system can cluster information based on location data (e.g., clustering based on similar zip codes, similar KMA (Key Market Area, such as a location or locations), similar states, etc.) to identify locations similar to each other. Locations similar to one another can have similar set of rules. This reduces the amount of data required for training the location-based machine learning model. For example, if the location data is a zip code or other postal code, the system can manipulate that zip code, resulting in a normalized zip code which can then input into the zip code machine learning model. To normalize the zip codes, the system can replace zip code values with key market area, state, and/or distance information, depending on the specific configuration. Likewise, if the location data includes a pick-up and a drop-off location in the form of addresses, the system can normalize both of those addresses, converting them into normalized addressed before inputting them into a pick-up/drop-off machine learning model.

In some configurations, the system can also perform a datetime manipulation on datetime information. From the date time info, the system can extract patterns based on the day of the week, time of the day, etc., to identify time-dependent data. For example, shipping rates for loads scheduled on a Friday or during after-hours may be higher than those of other days of the week or during day shifts. Likewise, seasonal data can be collected and used to train a seasonal machine learning model to make predictions based on seasonal fluctuations. When the datetime information is received, the date itself would not be the best input to the seasonal machine learning model. Instead, the system can manipulate the datetime information to determine what the season currently is based on that datetime information, then input the current season into the seasonal machine learning model. In the case of freight predictions, similar manipulations may be made regarding the PPI, holidays, the CASS FREIGHT INDEX (a measurement of the monthly aggregate deliveries of U.S. freight), fuel price data, and/or any other relevant data type. In other industries, the system may require different machine learning models which require different datetime manipulations.

In some configurations, there may be a subset of data which is closely correlated. In such cases, that subset of data may be used to form a multi-variable machine learning model within the multiple machine learning models. In the freight example, if the system has data regarding freight loads, the system may identify within the freight load data multiple variables which are associated with the respective loads, such as distance, volume, weight, and dimensions. In this case, the system can build a machine learning model specific to these data types, then add that multi-variable machine learning model to the other single-variable machine learning models within the multiple machine learning models the system generates. In the case of weather, the system may create multiple machine learning models based on single data sources (such as weather towers), but create a multi-variable machine learning model from a data source such as the National Weather Service.

The multiple machine learning models make predictions based on the data used to train the models. However, such training can be computationally expensive and/or time consuming. For example, because of the time consuming nature of training the multiple machine learning models, they may only be retrained once a month. However, this monthly retraining can mean that the models are not using the most recent data. To account for the most recent data, the system generates a multiplier which can be applied to the aggregated result from the multiple machine learning models. The multiplier is generated by a machine learning multiplier model which uses the most recent data to generate the multiplier. For example, the machine learning multiplier model can be trained using indicators which vary often, then use the latest values of those indicators as inputs during execution, resulting in the multiplier. The machine learning multiplier model provides the system with the ability to scale or weight the aggregated result of the multiple machine learning models in a manner faster than retraining all of the multiple machine learning models. Exemplary, non-limiting uses of the machine learning multiplier model with the aggregated result can be a factor, a product, or any other modification of the aggregated results based on the output of the machine learning multiplier model. To train the machine learning multiplier model, the system can use industry specific indicators. In the case of freight, this could be PPI, truck to load ratio, etc. In some cases, these industry specific indicators can be pieces of data which is also used to create individual, data-specific machine learning models within the multiple machine learning models.

The various machine learning models can be stored in a common database or storage medium, or can be stored across multiple databases/mediums. In some configurations, the execution of the machine learning models can occur in series or in parallel. In yet other configurations, the execution of the machine learning models can occur partially in series and partially in parallel. For example, execution of single and multi-variable machine learning models can be executed in parallel, with the results subsequently aggregated, and then the machine learning multiplier model can be executed. In other cases, the machine learning multiplier model can be executed in parallel with the other models.

Retraining of the machine learning models can occur on a periodic basis (such as when a given amount of time has passed, or when a certain number of iterations has occurred) or when error rates associated with a given model meet a predetermined threshold. For example, consider if the predetermined threshold for a given machine learning model is at five percent within ten iterations. If the error rate for predictions made by that machine learning model over the next ten iterations exceeds five percent, the system may retrain that machine learning model. In yet other cases, the machine learning models may be retrained upon a predetermined threshold of new training data being received. In some configurations, the prediction outputs of the respective machine learning models can be compared to the realized values for item being predicted, and differences between the predictions and reality can be used to retrain the models.

With that description the disclosure turns to the specific examples illustrated in the figures.

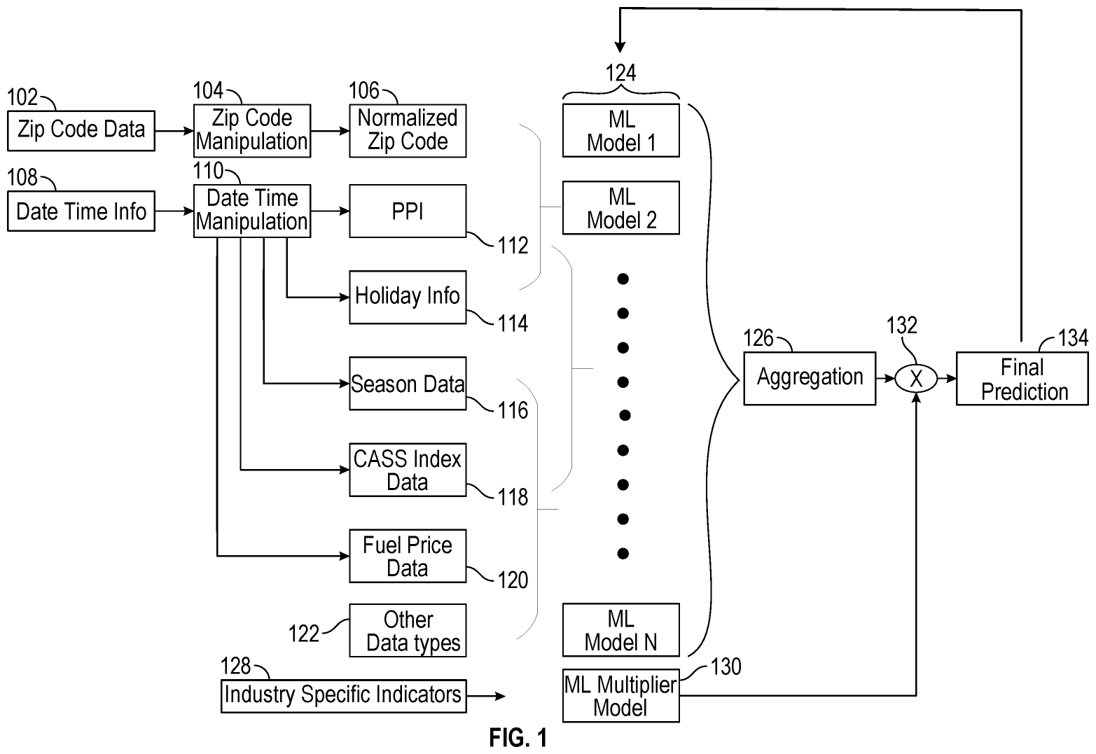

FIG. 1 illustrates a first example system configuration. In this example, the system trains machine learning models 124 associated with sets of one or more data types such as normalized zip code data 106, PPI data 112, holiday information 114, seasonal data 116, CASS FREIGHT INDEX data 118, and fuel price data 120, as well as at least one multi-variable machine learning model associated with other data types 122. These multiple machine learning models 124 are configured to receive data and generate predictions. Some of the data can be modified prior to being used as an input into the respective models. For example, the zip code data 102 can be manipulated 104 (e.g., changing the zip code to a city, state, or regional name). Likewise, datetime information 108 can be manipulated 110, resulting in or being combined with the PPI data 112, holiday information 114, seasonal data 116, CASS FREIGHT INDEX data 118, and fuel price data 120. The other data types 122 which may be used to create the multi-variable machine learning model(s) can include variables which are highly correlated or which are commonly provided together. One non-limiting example of other data types 112 can be distance, volume, weight, and dimensions of a load being transported when the system is configured to make freight predictions.

Training of the machine learning models 124 occurs using historical data associated with the sets of one or more variables for a given model. The system, upon inputting current data of the one or more variables into the models 124 and executing the models 124, obtains predictions from each model 124. These predictions are then aggregated together 126. The system can also train a machine learning multiplier model 130 using industry specific indicators 128. These industry specific indicators 128 can be anything related to the overall field which the system is being used to analyze/predict. Upon execution of the machine learning multiplier model 130 using current industry specific indicator 128 data, the system receives a multiplier which can be applied 132 to the aggregated 126 results of the multiple machine learning models 124. The result of the multiplier being applied 132 to the aggregation 126 results is a final prediction 134 (e.g., output), which can be forwarded to a user. As illustrated, in some configurations, the final prediction 134 can be used to retrain the machine learning models 124 and/or the machine learning multiplier model 130.

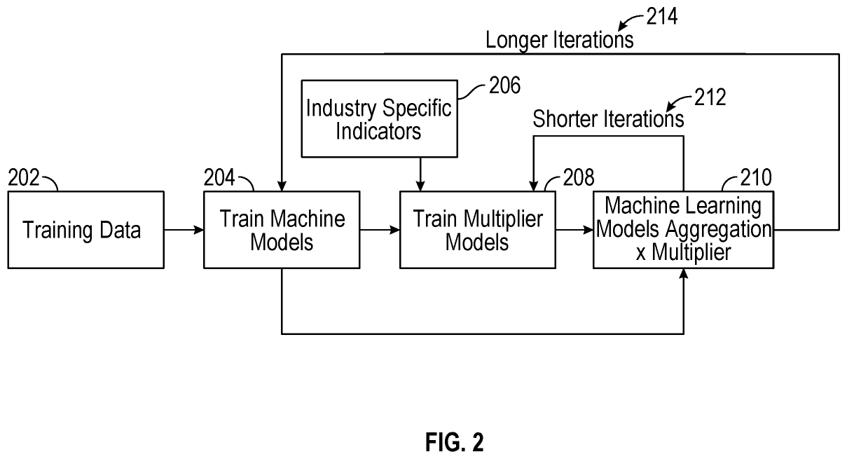

FIG. 2 illustrates an example of timing the training of the machine learning models. In this example, training data 202 is received and used to train machine learning models 204. Preferably, the training data 202 includes sets of data from multiple different data sources and data types, where different combinations of the data types can form different sets used to train the different machine learning models 204. These machine learning models 204 (and/or their outputs) can be used with industry specific indicators 206 to train a multiplier model 208. In other configurations, only the industry specific indicators 206 (and not the machine learning models 204) can be used to train the machine learning multiplier model 208. The aggregated outputs of the machine learning models 204 can be combined 210 with the multiplier output of the machine learning multiplier model 208, resulting in the final system prediction. As illustrated, this output can be used to retrain, over shorter iterations 212, the machine learning multiplier model 208. For example, rather than retrain all of the models 204 each time a prediction is made (based, for example, on a difference between the prediction and the actual result), something that would be computationally expensive, the system can instead only retrain the multiplier model 208. Retraining a single model 210, which can affect the overall result through the multiplier output it produces, can be done using fewer computational resources than retraining all models 204.

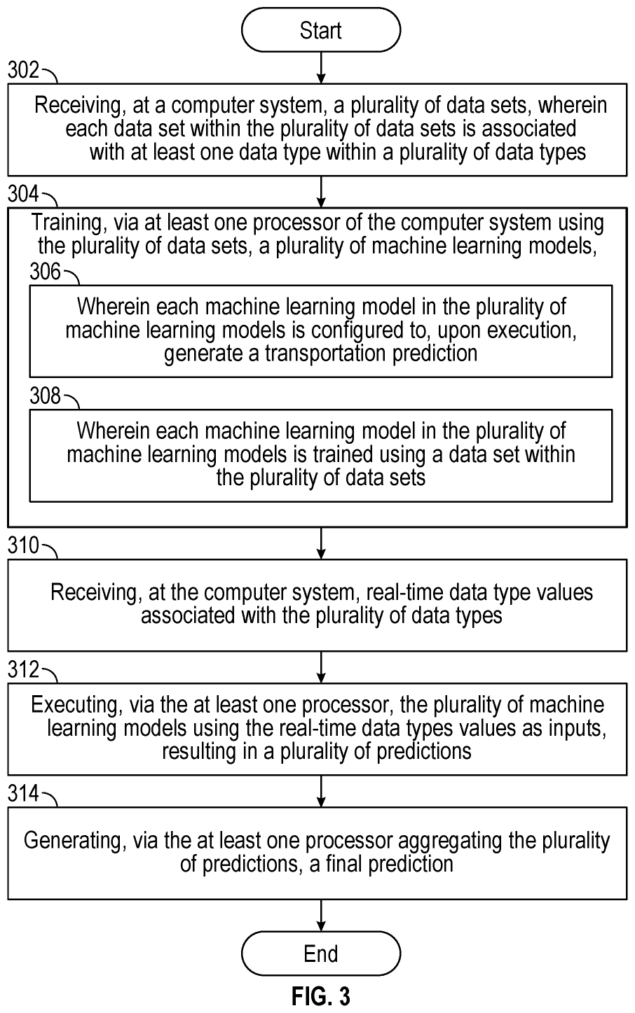

FIG. 3 illustrates an example method embodiment. As illustrated, the method can include receiving, at a computer system, a plurality of data sets, wherein each data set within the plurality of data sets is associated with at least one data type within a plurality of data types (302), then training, via at least one processor of the computer system using the plurality of data sets, a plurality of machine learning models (304). In the training of the machine learning models (304), each machine learning model in the plurality of machine learning models can be configured to, upon execution, generate a transportation prediction (306), and each machine learning model in the plurality of machine learning models can be trained using a data set within the plurality of data sets (308). The method can then include receiving, at the computer system, real-time data type values associated with the plurality of data types (310), executing, via the at least one processor, the plurality of machine learning models using the real-time data type values as inputs, resulting in a plurality of predictions (312), and generating, via the at least one processor aggregating the plurality of predictions, a final prediction (314).

In some configurations, the illustrated method can further include: receiving, at the computer system, past industry-specific indicators; training, via the at least one processor using the industry-specific indicators, a machine learning multiplier model; receiving, at the computer system, current industry-specific indicators; and executing, via the at least one processor, the machine learning multiplier model using the current industry-specific indicators as input, resulting in a multiplier, wherein the final prediction is further generated using the multiplier. In such configurations, the method can also include: receiving, at the computer system after generating the final prediction, an actual result; determining, via the at least one processor, that the actual result is distinct from the final prediction, resulting in a difference; retraining, via the at least one processor, the machine learning multiplier model using the industry-specific indicators and the difference, resulting in an updated machine learning multiplier model; and retraining, via the at least one processor, the plurality of machine learning models using the plurality of data sets and the difference, resulting in an updated plurality of machine learning models, wherein the updated machine learning multiplier model and the updated plurality of machine learning models are used in future iterations. The retraining of the machine learning multiplier model can occur more frequently than the retraining of the plurality of machine learning models. Alternatively, the retraining of the machine learning multiplier model and the retraining of the plurality of machine learning models can occur upon a predetermined number of iterations of the generating of the final prediction occurring.

In some configurations, the final prediction can be a freight transportation price.

In some configurations, the plurality of data types can include: holiday information, seasonal data, and fuel price data.

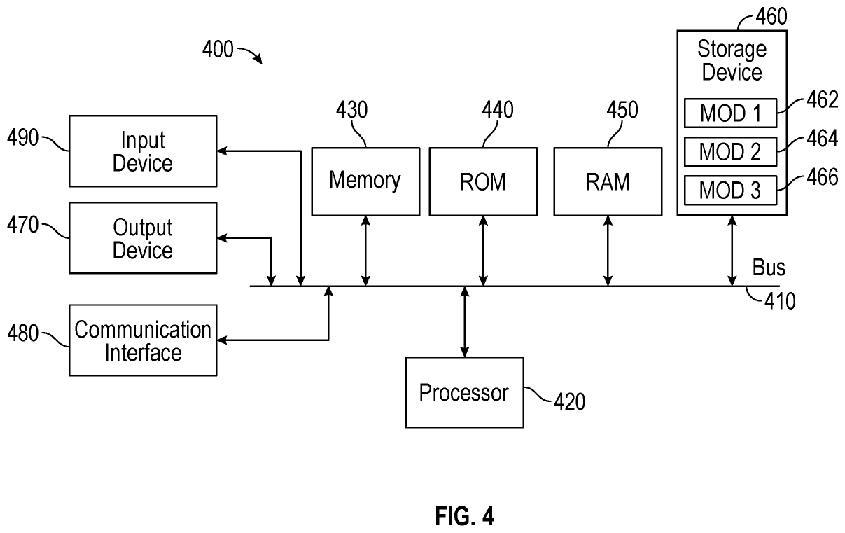

With reference to FIG. 4, an exemplary system includes a general-purpose computing device 400, including a processing unit (CPU or processor) 420 and a system bus 410 that couples various system components including the system memory 430 such as read-only memory (ROM) 440 and random-access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a plurality of data sets, wherein each data set within the plurality of data sets is associated with at least one data type within a plurality of data types; training, via at least one processor of the computer system using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving, at the computer system, real-time data type values associated with the plurality of data types; executing, via the at least one processor, the plurality of machine learning models using the real-time data type values as inputs, resulting in a plurality of predictions; and generating, via the at least one processor aggregating the plurality of predictions, a final prediction.

The method of any preceding clause, further comprising: receiving, at the computer system, past industry-specific indicators; training, via the at least one processor using the industry-specific indicators, a machine learning multiplier model; receiving, at the computer system, current industry-specific indicators; and executing, via the at least one processor, the machine learning multiplier model using the current industry-specific indicators as input, resulting in a multiplier, wherein the final prediction is further generated using the multiplier.

The method of any preceding clause, further comprising: receiving, at the computer system after generating the final prediction, an actual result; determining, via the at least one processor, that the actual result is distinct from the final prediction, resulting in a difference; retraining, via the at least one processor, the machine learning multiplier model using the industry-specific indicators and the difference, resulting in an updated machine learning multiplier model; and retraining, via the at least one processor, the plurality of machine learning models using the plurality of data sets and the difference, resulting in an updated plurality of machine learning models, wherein the updated machine learning multiplier model and the updated plurality of machine learning models are used in future iterations.

The method of any preceding clause, wherein the retraining of the machine learning multiplier model occurs more frequently than the retraining of the plurality of machine learning models.

The method of any preceding clause, wherein the retraining of the machine learning multiplier model and the retraining of the plurality of machine learning models occur upon a predetermined number of iterations of the generating of the final prediction occurring.

The method of any preceding clause, wherein the final prediction is a freight transportation price.

The method of any preceding clause, wherein the plurality of data types comprise: holiday information, seasonal data, and fuel price data.

A system comprising: at least one processor; and a non-transitory computer-readable storage medium having instructions which, when executed by the at least one processor, cause the at least one processor to perform operations comprising: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

The system of any preceding clause, the non-transitory computer-readable storage medium having additional instructions stored which, when executed by the at least one processor, cause the at least one processor to perform operations comprising: receiving past industry-specific indicators; training, using the industry-specific indicators, a machine learning multiplier model; receiving current industry-specific indicators; and executing the machine learning multiplier model using the current industry-specific indicators as input, resulting in a multiplier, wherein the final prediction is further generated using the multiplier.

The system of any preceding clause, the non-transitory computer-readable storage medium having additional instructions stored which, when executed by the at least one processor, cause the at least one processor to perform operations comprising: receiving, after generating the final prediction, an actual result; determining that the actual result is distinct from the final prediction, resulting in a difference; retraining the machine learning multiplier model using the industry-specific indicators and the difference, resulting in an updated machine learning multiplier model; and retraining the plurality of machine learning models using the plurality of data sets and the difference, resulting in an updated plurality of machine learning models, wherein the updated machine learning multiplier model and the updated plurality of machine learning models are used in future iterations.

The system of any preceding clause, wherein the retraining of the machine learning multiplier model occurs more frequently than the retraining of the plurality of machine learning models.

The system of any preceding clause, wherein the retraining of the machine learning multiplier model and the retraining of the plurality of machine learning models occur upon a predetermined number of iterations of the generating of the final prediction occurring.

The system of any preceding clause, wherein the final prediction is a freight transportation price.

The system of any preceding clause, wherein the plurality of data types comprise: holiday information, seasonal data, and fuel price data.

A non-transitory computer-readable storage medium having instructions which, when executed by at least one processor, cause the at least one processor to perform operations comprising: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

The non-transitory computer-readable storage medium of any preceding clause, having additional instructions stored which, when executed by the at least one processor, cause the at least one processor to perform operations comprising: receiving past industry-specific indicators; training, using the industry-specific indicators, a machine learning multiplier model; receiving current industry-specific indicators; and executing the machine learning multiplier model using the current industry-specific indicators as input, resulting in a multiplier, wherein the final prediction is further generated using the multiplier.

The non-transitory computer-readable storage medium of any preceding clause, having additional instructions stored which, when executed by the at least one processor, cause the at least one processor to perform operations comprising: receiving, after generating the final prediction, an actual result; determining that the actual result is distinct from the final prediction, resulting in a difference; retraining the machine learning multiplier model using the industry-specific indicators and the difference, resulting in an updated machine learning multiplier model; and retraining the plurality of machine learning models using the plurality of data sets and the difference, resulting in an updated plurality of machine learning models, wherein the updated machine learning multiplier model and the updated plurality of machine learning models are used in future iterations.

The non-transitory computer-readable storage medium of any preceding clause, wherein the retraining of the machine learning multiplier model occurs more frequently than the retraining of the plurality of machine learning models.

The non-transitory computer-readable storage medium of any preceding clause, wherein the retraining of the machine learning multiplier model and the retraining of the plurality of machine learning models occur upon a predetermined number of iterations of the generating of the final prediction occurring.

The non-transitory computer-readable storage medium of any preceding clause, wherein the final prediction is a freight transportation price.

A method of using multiple machine learning models for transportation predictions, comprising: receiving, at a computer system, a plurality of data sets, wherein each data set within the plurality of data sets is associated with at least one data type within a plurality of data types; training, via at least one processor of the computer system using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving, at the computer system, real-time data type values associated with the plurality of data types; executing, via the at least one processor, the plurality of machine learning models using the real-time data type values as inputs, resulting in a plurality of predictions; and generating, via the at least one processor aggregating the plurality of predictions, a final prediction.

The method of any preceding clause, further comprising: receiving, at the computer system, past industry-specific indicators; training, via the at least one processor using the industry-specific indicators, a machine learning multiplier model; receiving, at the computer system, current industry-specific indicators; and executing, via the at least one processor, the machine learning multiplier model using the current industry-specific indicators as input, resulting in a multiplier, wherein the final prediction is further generated using the multiplier.

The method of any preceding clause, further comprising: receiving, at the computer system after generating the final prediction, an actual result; determining, via the at least one processor, that the actual result is distinct from the final prediction, resulting in a difference; retraining, via the at least one processor, the machine learning multiplier model using the industry-specific indicators and the difference, resulting in an updated machine learning multiplier model; and retraining, via the at least one processor, the plurality of machine learning models using the plurality of data sets and the difference, resulting in an updated plurality of machine learning models, wherein the updated machine learning multiplier model and the updated plurality of machine learning models are used in future iterations.

The method of any preceding clause, wherein the retraining of the machine learning multiplier model occurs more frequently than the retraining of the plurality of machine learning models.

The method of any preceding clause, wherein the retraining of the machine learning multiplier model and the retraining of the plurality of machine learning models occur upon a predetermined number of iterations of the generating of the final prediction occurring.

The method of any preceding clause, wherein the final prediction is a freight transportation price.

The method of any preceding clause, wherein the plurality of data types comprise: holiday information, seasonal data, and fuel price data.

A system of using multiple machine learning models for transportation predictions, comprising: at least one processor; and a non-transitory computer-readable storage medium configured to, with the at least one processor, cause the system to perform operations comprising: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

The system of any preceding clause, wherein the non-transitory computer-readable storage medium is further configured to, with the at least one processor, cause the system to perform operations comprising: receiving past industry-specific indicators; training, using the industry-specific indicators, a machine learning multiplier model; receiving current industry-specific indicators; and executing the machine learning multiplier model using the current industry-specific indicators as input, resulting in a multiplier, wherein the final prediction is further generated using the multiplier.

The system of any preceding clause, wherein the non-transitory computer-readable storage medium is further configured to, with the at least one processor, cause the system to perform operations comprising: receiving, after generating the final prediction, an actual result; determining that the actual result is distinct from the final prediction, resulting in a difference; retraining the machine learning multiplier model using the industry-specific indicators and the difference, resulting in an updated machine learning multiplier model; and retraining the plurality of machine learning models using the plurality of data sets and the difference, resulting in an updated plurality of machine learning models, wherein the updated machine learning multiplier model and the updated plurality of machine learning models are used in future iterations.

The system of any preceding clause, wherein the retraining of the machine learning multiplier model occurs more frequently than the retraining of the plurality of machine learning models.

The system of any preceding clause, wherein the retraining of the machine learning multiplier model and the retraining of the plurality of machine learning models occur upon a predetermined number of iterations of the generating of the final prediction occurring.

The system of any preceding clause, wherein the final prediction is a freight transportation price.

The system of any preceding clause, wherein the plurality of data types comprise: holiday information, seasonal data, and fuel price data.

A non-transitory computer-readable storage medium that stores a method of using multiple machine learning models for transportation predictions, the method comprising: receiving a plurality of data sets, wherein each data set within the plurality of data sets is associated with a different data type within a plurality of data types; training, using the plurality of data sets, a plurality of machine learning models, wherein each machine learning model in the plurality of machine learning models is configured to, upon execution, generate a transportation prediction; and wherein each machine learning model in the plurality of machine learning models is trained using a data set within the plurality of data sets; receiving real-time data type values associated with the plurality of data types; executing the plurality of machine learning models using the real-time data type values as inputs, resulting in a plurality of predictions; and generating, by aggregating the plurality of predictions, a final prediction.

The non-transitory computer-readable storage medium of claim 8, wherein the method stored therein further comprises: receiving past industry-specific indicators; training, using the industry-specific indicators, a machine learning multiplier model; receiving current industry-specific indicators; and executing the machine learning multiplier model using the current industry-specific indicators as input, resulting in a multiplier, wherein the final prediction is further generated using the multiplier.

The non-transitory computer-readable storage medium of any preceding clause, wherein the method stored therein further comprises: receiving, after generating the final prediction, an actual result; determining that the actual result is distinct from the final prediction, resulting in a difference; retraining the machine learning multiplier model using the industry-specific indicators and the difference, resulting in an updated machine learning multiplier model; and retraining the plurality of machine learning models using the plurality of data sets and the difference, resulting in an updated plurality of machine learning models, wherein the updated machine learning multiplier model and the updated plurality of machine learning models are used in future iterations.

The non-transitory computer-readable storage medium of any preceding clause, wherein the retraining of the machine learning multiplier model occurs more frequently than the retraining of the plurality of machine learning models.

The non-transitory computer-readable storage medium of any preceding clause, wherein the retraining of the machine learning multiplier model and the retraining of the plurality of machine learning models occur upon a predetermined number of iterations of the generating of the final prediction occurring.

The non-transitory computer-readable storage medium of any preceding clause, wherein the final prediction is a freight transportation price.

We claim:

1. A method comprising:
receiving, at a computer system, a plurality of data sets, wherein each data set within the plurality of data sets is associated with at least one data type within a plurality of data types;
training, via at least one processor of the computer system using the plurality of data sets, a plurality of machine learning models,
wherein each machine learning model in the plurality of machine learning models is configured to, upon execution, generate a transportation prediction; and
wherein each machine learning model in the plurality of machine learning models is trained using a data set within the plurality of data sets;
receiving, at the computer system, real-time data type values associated with the plurality of data types;
executing, via the at least one processor, the plurality of machine learning models using the real-time data type values as inputs, resulting in a plurality of predictions; and
generating, via the at least one processor aggregating the plurality of predictions, a final prediction.

2. The method of claim 1, further comprising:
receiving, at the computer system, past industry-specific indicators;
training, via the at least one processor using the industry-specific indicators, a machine learning multiplier model;
receiving, at the computer system, current industry-specific indicators; and
executing, via the at least one processor, the machine learning multiplier model using the current industry-specific indicators as input, resulting in a multiplier,
wherein the final prediction is further generated using the multiplier.

3. The method of claim 2, further comprising:
receiving, at the computer system after generating the final prediction, an actual result;
determining, via the at least one processor, that the actual result is distinct from the final prediction, resulting in a difference;
retraining, via the at least one processor, the machine learning multiplier model using the industry-specific indicators and the difference, resulting in an updated machine learning multiplier model; and
retraining, via the at least one processor, the plurality of machine learning models using the plurality of data sets and the difference, resulting in an updated plurality of machine learning models,
wherein the updated machine learning multiplier model and the updated plurality of machine learning models are used in future iterations.

4. The method of claim 3, wherein the retraining of the machine learning multiplier model occurs more frequently than the retraining of the plurality of machine learning models.

5. The method of claim 3, wherein the retraining of the machine learning multiplier model and the retraining of the plurality of machine learning models occur upon a predetermined number of iterations of the generating of the final prediction occurring.

6. The method of claim 1, wherein the final prediction is a freight transportation price.

7. The method of claim 1, wherein the plurality of data types comprise: holiday information, seasonal data, and fuel price data.

8. A system comprising:
at least one processor; and
a non-transitory computer-readable storage medium having instructions which, when executed by the at least one processor, cause the at least one processor to perform operations comprising:
receiving a plurality of data sets, wherein each data set within the plurality of data sets is associated with a different data type within a plurality of data types;
training, using the plurality of data sets, a plurality of machine learning models,
wherein each machine learning model in the plurality of machine learning models is configured to, upon execution, generate a transportation prediction; and
wherein each machine learning model in the plurality of machine learning models is trained using a data set within the plurality of data sets;
receiving real-time data type values associated with the plurality of data types;
executing the plurality of machine learning models using the real-time data type values as inputs, resulting in a plurality of predictions; and
generating, by aggregating the plurality of predictions, a final prediction.

9. The system of claim 8, the non-transitory computer-readable storage medium having additional instructions stored which, when executed by the at least one processor, cause the at least one processor to perform operations comprising:
receiving past industry-specific indicators;
training, using the industry-specific indicators, a machine learning multiplier model;
receiving current industry-specific indicators; and
executing the machine learning multiplier model using the current industry-specific indicators as input, resulting in a multiplier,
wherein the final prediction is further generated using the multiplier.

10. The system of claim 9, the non-transitory computer-readable storage medium having additional instructions stored which, when executed by the at least one processor, cause the at least one processor to perform operations comprising:
receiving, after generating the final prediction, an actual result;
determining that the actual result is distinct from the final prediction, resulting in a difference;
retraining the machine learning multiplier model using the industry-specific indicators and the difference, resulting in an updated machine learning multiplier model; and
retraining the plurality of machine learning models using the plurality of data sets and the difference, resulting in an updated plurality of machine learning models,
wherein the updated machine learning multiplier model and the updated plurality of machine learning models are used in future iterations.

11. The system of claim 10, wherein the retraining of the machine learning multiplier model occurs more frequently than the retraining of the plurality of machine learning models.

12. The system of claim 10, wherein the retraining of the machine learning multiplier model and the retraining of the plurality of machine learning models occur upon a predetermined number of iterations of the generating of the final prediction occurring.

13. The system of claim 8, wherein the final prediction is a freight transportation price.

14. The system of claim 8, wherein the plurality of data types comprise: holiday information, seasonal data, and fuel price data.

15. A non-transitory computer-readable storage medium having instructions which, when executed by at least one processor, cause the at least one processor to perform operations comprising:
receiving a plurality of data sets, wherein each data set within the plurality of data sets is associated with a different data type within a plurality of data types;
training, using the plurality of data sets, a plurality of machine learning models,
wherein each machine learning model in the plurality of machine learning models is configured to, upon execution, generate a transportation prediction; and
wherein each machine learning model in the plurality of machine learning models is trained using a data set within the plurality of data sets;
receiving real-time data type values associated with the plurality of data types;
executing the plurality of machine learning models using the real-time data type values as inputs, resulting in a plurality of predictions; and
generating, by aggregating the plurality of predictions, a final prediction.

16. The non-transitory computer-readable storage medium of claim 8, having additional instructions stored which, when executed by the at least one processor, cause the at least one processor to perform operations comprising:
receiving past industry-specific indicators;
training, using the industry-specific indicators, a machine learning multiplier model;
receiving current industry-specific indicators; and
executing the machine learning multiplier model using the current industry-specific indicators as input, resulting in a multiplier,
wherein the final prediction is further generated using the multiplier.

17. The non-transitory computer-readable storage medium of claim 16, having additional instructions stored which, when executed by the at least one processor, cause the at least one processor to perform operations comprising:
receiving, after generating the final prediction, an actual result;
determining that the actual result is distinct from the final prediction, resulting in a difference;
retraining the machine learning multiplier model using the industry-specific indicators and the difference, resulting in an updated machine learning multiplier model; and
retraining the plurality of machine learning models using the plurality of data sets and the difference, resulting in an updated plurality of machine learning models,
wherein the updated machine learning multiplier model and the updated plurality of machine learning models are used in future iterations.

18. The non-transitory computer-readable storage medium of claim 17, wherein the retraining of the machine learning multiplier model occurs more frequently than the retraining of the plurality of machine learning models.

19. The non-transitory computer-readable storage medium of claim 17, wherein the retraining of the machine learning multiplier model and the retraining of the plurality of machine learning models occur upon a predetermined number of iterations of the generating of the final prediction occurring.

20. The non-transitory computer-readable storage medium of claim 15, wherein the final prediction is a freight transportation price.
